(19) United States
(12) Patent Application Publication
(10) Pub. No.: US 2019/0154072 A1
(43) Pub. Date: May 23, 2019

(54) SCREW ANCHORS AND MANUFACTURING METHODS

(71) Applicant: Black & Decker Inc., New Britain, CT (US)

(72) Inventor: Philipp MAHRENHOLTZ, Frankfurt (DE)

(21) Appl. No.: 15/816,223

(22) Filed: Nov. 17, 2017

(51) Int. Cl. F16B 25/00; B23K 26/342; B21H 3/02

(52) U.S. Cl. CPC F16B 25/0026; B21H 3/027; B23K 26/342; F16B 25/0057

(57) ABSTRACT

A screw anchor and method of forming such a screw anchor, the method comprising: forming a first male screw thread section on a metallic body and which is integral to the metallic body; and using a metal deposition technique to deposit a second male screw thread section on the metallic body; wherein the second male screw thread section is formed of metallic material having a greater hardness than the metallic body and is able to tap out a female thread in a hole in a support for receiving the first male screw thread section when the screw anchor is twisted into the hole.

### FIELD OF THE INVENTION

This specification concerns screw anchors and methods of manufacturing.

### BACKGROUND OF THE INVENTION

Concrete screw anchors are screwed into holes pre-drilled in concrete. These holes have no internally threaded surface which requires concrete screw anchors to tap out their own receiving thread while being inserted. It is known to form concrete screw anchors from stainless steel to benefit from its corrosion resistant properties, however, problems occur if concrete screw anchors are formed entirely of stainless steel. This is because stainless steel is not as hard as concrete and so a concrete screw anchor entirely formed of stainless steel will not be able to tap out its own receiving thread. A solution to this issue is described in EP2501944B1 in which a leading part of the thread of a concrete screw anchor is formed of material which is hard enough to tap out a receiving thread in concrete. However, with reference to FIGS. 1 and 2 herein, the manufacturing method described in EP2501944B1 of forming a coil 1 of hard material and also a receiving channel 2 in an anchor body 3 for receiving the coil 1 such that it forms a continuation of the integral screw thread portion 4, all within narrow manufacturing tolerances, is technically difficult. Aspects of the invention described herein provide an alternative approach.

### BRIEF SUMMARY OF THE INVENTION

According to an aspect of the invention there is provided a method according to claim 1. Optional steps and embodiments are provided in claims 2 to 8.

According to another aspect of the invention there is provided a screw anchor according to claim 9. Optional embodiments are provided in claims 9 to 14.

According to a further aspect of the invention there is provided the use of a metal deposition technique as provided in claim 15 to form a screw thread section of a screw anchor.

### BRIEF DESCRIPTION OF THE DRAWINGS

Various aspects and embodiments of the invention will now be described by way of non-limiting example with reference to the accompanying drawings, in which:

FIG. 1 illustrates a prior art concrete screw anchor being manufactured and

FIG. 2 illustrates the prior art concrete screw anchor of FIG. 1 when completed;

FIG. 3 illustrates a manufacturing method according to an embodiment;

FIG. 4 schematically illustrates an anchor blank obtained from step S3 in FIG. 3; and

FIG. 5 schematically illustrates a concrete screw anchor obtained from step S4 in FIG. 3.

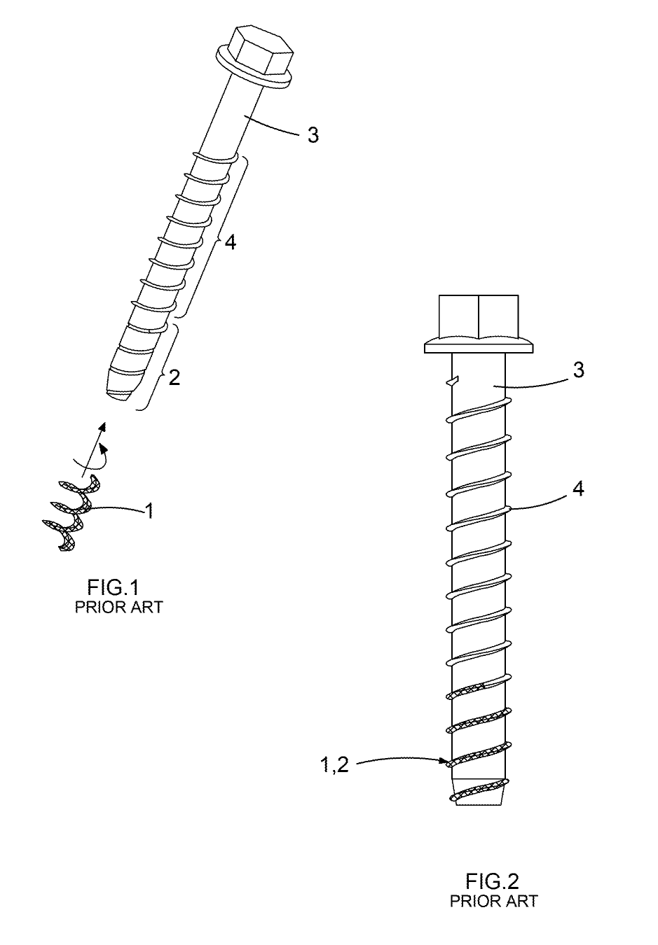

### DETAILED DESCRIPTION OF THE INVENTION

Aspects and embodiments of the present invention concern a concrete screw anchor formed as a single metallic piece save for a leading part of a screw thread on its exterior surface which is formed of another type of metallic material that is harder than the rest of the anchor and which is deposited thereon using a metal deposition manufacturing technique.

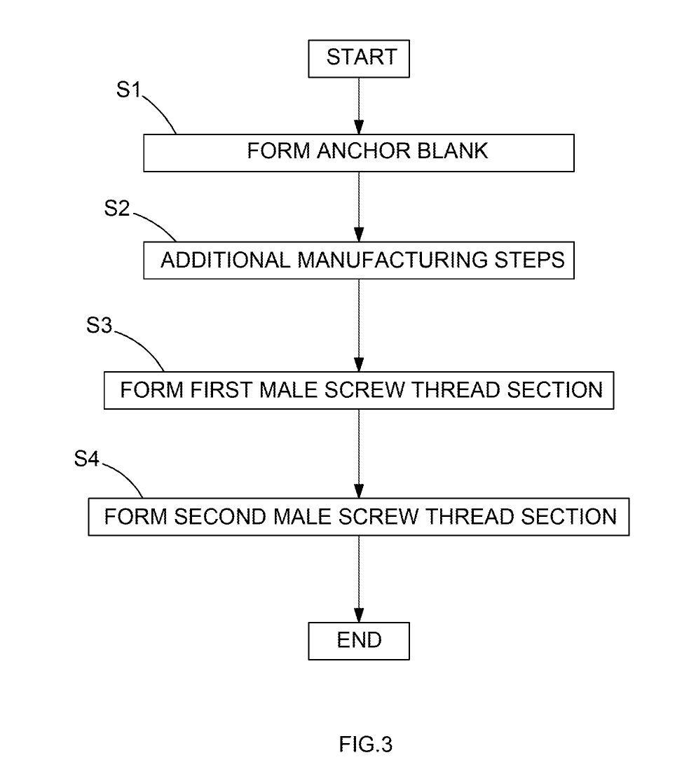

With reference to FIG. 3 a method of manufacturing a concrete screw anchor formed of stainless steel and having a carbon steel leading screw thread part is as follows.

In step S1 a body of stainless steel is formed into a substantially cylindrical anchor blank, wherein techniques of achieving this are well known and will be familiar to persons skilled in the art so are not described in detail here. Briefly however, an example suitable method involves drawing a stainless steel wire until a desired wire thickness is achieved and then cutting a section of length of the wire such that the resulting section (the anchor blank) also has a predetermined length.

In step S2 additional manufacturing steps may be performed on the anchor blank such has forming a head portion at one end by impacting the anchor blank, wherein such a head portion can cooperate with a screw device to facilitate screwing of the concrete screw anchor—to be formed—into a hole in some concrete. Also any embellishments that a manufacturer may wish the end product to exhibit may be stamped into the anchor blank. For example a manufacturer's logo or details of performance characteristics may be stamped on the anchor head portion.

In step S3 a first male screw thread section having a plurality of turns is formed on the exterior of the anchor blank obtained from step S2, wherein techniques of achieving this are also well known and will be familiar to persons skilled in the art so are not described in detail here. Briefly however an example suitable method involves rolling the section of the anchor blank where the male screw thread section is to be formed between opposing dies to form the male screw thread section in its outer surface. The first male screw thread section having a plurality of turns, however, only extends partially along the length of the anchor blank and does not extend all the way to the leading end of the concrete screw anchor being formed.

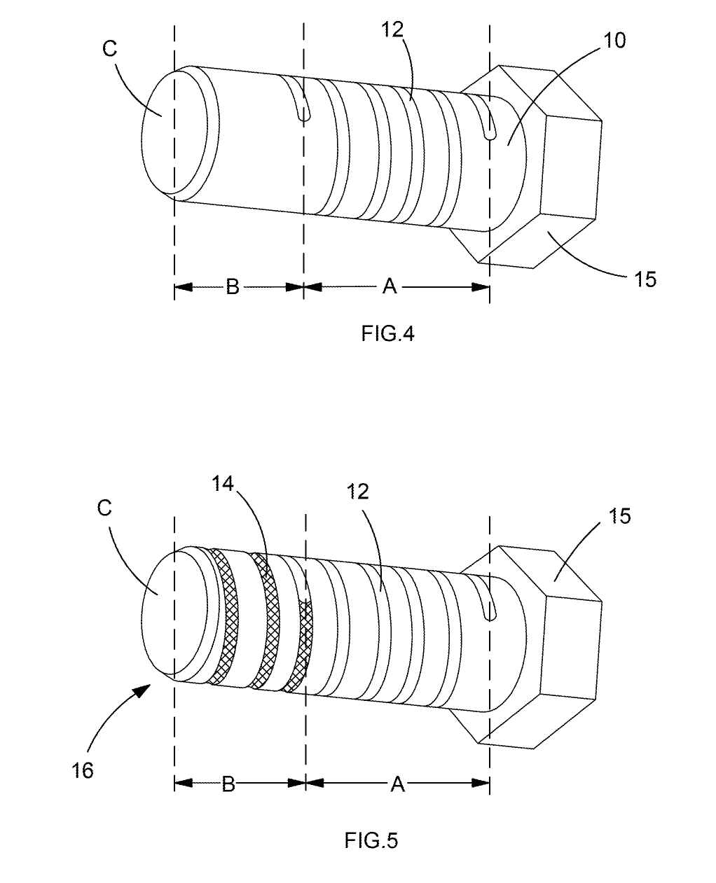

FIG. 4 schematically illustrates an example arrangement obtained from implementing step S3 in which an anchor blank 10 has had a first male screw thread section 12 formed on its outer surface, wherein this screw thread section only extends along part of its length denoted A. The first male screw thread section 12 can have a cross sectional profile and pitch suited to a specific intended function of the anchor to be formed. In other words persons skilled in the art are free to choose a cross sectional profile and pitch of the first male screw thread section 12 in order to achieve specific performance characteristics of the anchor to be formed. The section of length of the arrangement denoted B begins with the end of the first male screw thread section 12 and ends with the end of the anchor blank 10 denoted C, wherein this end is intended to form the leading part of the anchor to be formed during use. A head portion 15 as heretofore described for cooperating with a device for screwing the concrete screw anchor being formed into a hole in some concrete is also shown.

In step S4 a second male screw thread section having a plurality of turns (e.g. 2 to 4) is formed on the exterior of the anchor blank 10 obtained from step S3. Looking at FIG. 5 the second male screw thread section 14 has a similar pitch as the first male screw thread section 12. Dimensions of the second male screw thread section 14 will be discussed in more detail later on, although the cross-sectional profile of this thread section must be sufficient to tap out a female thread in concrete which can receive the first male screw thread section 12. Moreover the second male screw thread section 14 begins substantially where the first male screw thread section 12 ends and continues up to the aforementioned leading end C of the anchor to be formed.

The second male screw thread section 14 is formed of carbon steel and can be deposited on the stainless steel anchor blank 10 obtained from step S3 using a laser metal deposition (LMD) technique such as laser surface cladding. Laser surface cladding, a known technique, involves using a laser to create a melting bath on the surface of the stainless steel anchor blank 10 to which a powdered carbon steel material is added. The surface and the powdered additive are melted which creates a melt-metallurgic connection between the two materials which hardens when cooled.

A suitable apparatus for forming a male screw thread as described using a laser metal deposition technique is a machine from the Trumpf TruLaser Cell Series, which can be used to implement laser metal deposition techniques and are obtainable from TRUMPF GmbH+Co. KG at Johann-Maus-Str. 2, 71254 Ditzingen, Germany. An anchor blank 10 obtained from step S3 can be clamped in such a machine and then caused to move such that the areas of surface where the second male screw thread section 14 are to be deposited move past the welding point.

Alternatively though other techniques can be used to form the second male screw thread section 14 such as plasma-transferred-arc (PTA) welding, a metal inert gas (MIG) welding technique or a metal active gas (MAG) welding technique can be used.

It is here mentioned that in implementing laser metal deposition or plasma-transferred-arc welding the material that will become the second male screw thread section is provided, for use in that manufacturing process, in powder form. However in implementing metal inert gas welding or metal active gas welding the material that will become the second male screw thread section is provided, for use in that manufacturing process, in wire form.

When implementing a metal deposition technique to form the second male screw thread section 14, one layer of second male screw thread section material is sufficient. Though technically feasible, there is no advantage in building up the second male screw thread section 14 using a plurality of separate layers, similar to more widely known additive manufacturing techniques commonly referred to as 3D printing.

A completed concrete screw anchor resulting from step S4 is denoted 16 in FIG. 5.

Positively manufacturing techniques like hardening, quenching and tempering subsequent to implementing step S4 are not required. When the concrete screw anchor 16 resulting from step S4 is screwed into a hole in some concrete the second male screw thread section 14 formed of carbon steel taps a female thread into the concrete as the concrete screw anchor 16 is twisted into the hole. As the concrete screw anchor 16 is further rotated into the receiving hole, the first male screw thread section 12 enters the tapped out female thread for retaining the anchor in the hole.

Although the foregoing has been described in the context of a stainless steel concrete screw anchor provided with a leading carbon steel thread section, other specific materials can be used instead. For instance in addition to the possibility of forming the anchor blank 10 from stainless steel it could alternatively be formed of a first metallic material more generally that is not necessarily stainless steel such as aluminium, copper or brass. Furthermore in addition to the possibility of forming the second male screw thread section 14 from carbon steel it could alternatively be formed of a second metallic material more generally that is not necessarily carbon steel, provided however that it is harder than the first metallic material used to form the anchor blank 10 and is also harder than the concrete through which it is required to cut. For example in some embodiments the second male screw thread section 14 can be formed of an alloy such as an alloy based on iron, chrome and/or cobalt wherein the specific elements and their respective ratios can be chosen depending on the performance characteristics of the concrete screw anchor 16 to be formed.

In some embodiments the second male screw thread section 14 (i.e. the leading male screw thread section) has a Rockwell Hardness of about 56 HRC or greater. In some embodiments the second male screw thread section 14 has a Rockwell Hardness of about 56 HRC to about 64 HRC. In some embodiments the second male screw thread section 14 has a Rockwell Hardness of about 59 HRC to about 61 HRC. In some embodiments the second male screw thread section 14 has a Rockwell Hardness of about 60 HRC. Although the specific hardness utilised in a particular embodiment is dependent on the required performance characteristics and financial constraints which could have an impact on the specific materials available to form the anchor from.

Due to the range of potential materials that could be used to form a concrete screw anchor depending on the required performance characteristics and financial constraints, as heretofore described, it is here mentioned that by having both the first and second male screw thread sections formed of corrosion resistant material the concrete screw anchor is less likely to degrade during its service lifetime. This is advantageous because material expansion caused by corrosion is less likely to occur during the service lifetime, thereby reducing the risk of concrete cracking due to expansion forces. Also, by reducing the likelihood of the screw thread sections from degrading during the service lifetime of a concrete screw anchor, the pull out strength of the concrete screw anchor is less likely to change over time due to a decreasing amount of screw thread maintaining the anchor in place from corrosion.

As already mentioned the profile of the second male screw thread section 14 should be at least as large as the profile of the first male screw thread section 12 in order to be able to tap a suitable female receiving thread into concrete during use. Preferably the material used to form the second male screw thread section 14 should not wear in use, although due to economic constraints the material chosen might wear slightly when tapping out a female thread in use. The specific profile shape chosen for the second male screw thread section 14 is thus dependent on the material used to form it. This is because the extent to which it is likely to wear in use must be taken into account to reduce the likelihood of the profile of the second male screw thread section 14 falling below the profile of the first male screw thread section 12. Of course oversized thread profiles, on the other hand, have the disadvantage of tapping larger cavities into concrete at the beginning of the tapping process which reduces the tightness of the fit of the concrete screw anchor 16 when fully screwed into a hole in use. Thus a balance is to be struck between the likely extent of wear and the resultant tightness of fit of the concrete screw anchor 16 in use.

From the foregoing it should be apparent that no specific cross sectional profile of the male screw thread sections 12, 14 is preferred. The specific cross sectional profile to be used on a concrete screw anchor 16 depends on the performance characteristics required of the concrete screw anchor 16 to be formed and the materials used to form respective components of the concrete screw anchor 16; which are dependent on conditions of the environment in which the concrete screw anchor 16 is intended to be used (e.g. corrosive resistant materials will likely be chosen for applications in corrosive environment scenarios ranging from wet indoor or outdoor areas, to highly corrosive environment like e.g. road tunnels, swimming pools, splash water zones, and areas close to chemical industries) and economic constraints which may limit the types of material that can be chosen to manufacture a concrete screw anchor 16.

Although the foregoing has been described in the context of a concrete screw anchor having a single thread, albeit being formed of first and second male screw thread sections, in some embodiments the anchor may include two or more parallel or axially offset helical screw threads, each having first and second male screw thread sections as heretofore described.

In some embodiments each respective screw thread section of the concrete screw anchor formed by the aforementioned manufacturing method may have profile characteristics similar to the anchor described in U.S. Pat. No. 8,430,619 which is incorporated herein by reference in its entirety, see for example between column 2, lines 26 to 49 of this document. In other words each respective male screw thread section (whether a leading thread section 14 having a greater hardness or a trailing thread section 12) may have such profile characteristics.

In some embodiments each respective screw thread section of the concrete screw anchor formed by the aforementioned manufacturing method may have profile characteristics similar to the anchor described in U.S. Pat. No. 7,056,075B2 the entire contents of which are incorporated herein by reference, see for example between column 3, lines 39 to 65 of this document. In other words each respective male screw thread section (whether a leading thread section 14 having a greater hardness than a trailing thread section 12) may have such profile characteristics. This passage itself refers to other examples of thread patterns suited for tapping masonry in U.S. Pat. Nos. 6,419,435 and 5,957,646 which are both also incorporated herein in their entirety by reference.

It will be appreciated that whilst various aspects and embodiments have heretofore been described, the scope of the present invention is not limited thereto and instead extends to encompass all methods and arrangements, and modifications and alterations thereto, which fall within the spirit and scope of the appended claims.

For example in some embodiments step S3 may be omitted and the entire male screw thread of a concrete screw anchor can be formed using a metal deposition technique.

In some embodiments the ratio of the aforementioned lengths A and B in FIG. 5 can be about 0%:100%. Although in some embodiments this ratio can be about 25%:75%. In some other embodiments this ratio can be about 50%:50%. In some other embodiments this ratio can be about 75%:25%. In some other embodiments this ratio can be about 80%:20%. In some other embodiments this ratio can be about 90%:10%. Thus the ratio of the aforementioned lengths A and B in FIG. 5 can range between about 0%:100% to about 90%:10%. Although this range is not intended to be limiting and it is again mentioned that the specific ratio utilised in a particular embodiment is dependent on the required performance characteristics of the screw anchor to be formed and financial constraints which could have an impact on the specific materials available to form the anchor from.

Furthermore, the amount or length of screw thread 14 may be defined in terms the B dimension. For example, second male threaded section 14 may cover an axial length from lead end C of about 2 to 4 turns, or depending on diameter, about 5 mm to 20 mm Flank angle ratio may be 1.0. Otherwise, a flank angle ratio may be between 2:1 and 1:2 or may between 3:2 and 2:3.

In some embodiments before a male screw thread section is formed as in step S4, a groove is formed in the anchor blank 10. Such a groove may have a U or V shaped cross-sectional profile.

Subsequently a male screw thread section can be formed using a metal deposition technique as heretofore described, although its base is located in the groove instead of on the outer surface of the anchor blank 10, which increases robustness of the connection between the thread and the anchor blank.

In some embodiments the second male screw thread section 14 could be provided with teeth, or in other words be serrated, for increasing the efficiency with which it can cut through concrete, which can be achieved either by a controlled variation of the weld thickness or by applying a dashed weld thread in another method step.

In some embodiments a gap may exist between an end portion of the first male screw thread section 12 and a beginning of the second male screw thread section 14, although nevertheless due to the second male screw thread section 14 being closer to the leading end C it can still tap a female receiving thread into concrete for receiving the first male screw thread section 12 in use. In other words, the end portion of the first male screw thread section 12 and the beginning portion of the second male screw thread section do not need to be in physical contact.

In some embodiments the second male screw thread section 14 can be a single turn and does not necessarily need to comprise a plurality of turns as heretofore described with reference to FIG. 5. In some further envisaged embodiments the second male screw thread section 14 can comprise less than a single turn, in other words it can comprise a portion of a turn, provided that it is capable of tapping out a female receiving thread in a hole in some concrete which the first male screw thread section 12 can be received within for maintaining the anchor 16 inside the hole.

In some embodiments the second male screw thread section 14 does not extend all the way to the leading end C of the anchor 16 as heretofore described with reference to FIG. 5. Instead the second male screw thread section 14 can terminate before reaching the leading end C, provided that it is capable of tapping out a female receiving thread in a hole in some concrete which the first male screw thread section 12 can be received within for maintaining the anchor 16 inside the hole.

Finally it is here mentioned that although the foregoing is set out in the context of concrete screw anchors, it will be appreciated by persons skilled in the art that the teachings can be applied more generally to screw anchors configured for self-tapping in a support formed of material that need not necessarily be concrete, for example brick masonry or stone.

1. A method of forming a screw anchor comprising: forming a first male screw thread section on a metallic body and which is integral to the metallic body; and using a metal deposition technique to deposit a second male screw thread section on the metallic body; wherein the second male screw thread section is formed of metallic material having a greater hardness than the metallic body and is able to tap out a female thread in a hole in a support for receiving the first male screw thread section when the screw anchor is twisted into the hole.

2. The method of claim 1, wherein the second male screw thread section is deposited on the metallic body using a laser metal deposition technique, a plasma transferred arc welding technique, a metal inert gas welding technique or a metal active gas welding technique.

3. The method of claim 1, wherein area sections of the metallic body where the second male screw thread section is to be deposited are moved past a welding point for depositing the second male screw thread section thereon.

4. The method of claim 1, wherein the second male screw thread section is formed of carbon steel.

5. The method of claim 1, wherein the second male screw thread section is formed of a metal alloy.

6. The method of claim 5, wherein the metal alloy is based on iron, chrome and/or cobalt.

7. The method of claim 1, wherein the metallic body and thus the first male screw thread section that is integral thereto are formed of stainless steel.

8. The method of claim 1, wherein the second male screw thread section comprises at least part of a screw thread turn.

9. A screw anchor comprising a metallic body portion with a first male screw thread section integral to the body portion and a second male screw thread section that has been deposited on the body portion by a metal deposition technique, wherein the second male screw thread section is formed of metallic material having a greater hardness than the metallic body portion and is able to tap out a female thread in a hole in a support for receiving the first male screw thread section when the screw anchor is twisted into the hole.

10. The screw anchor of claim 9, wherein the second male screw thread section is formed of carbon steel.

11. The screw anchor of claim 9, wherein the second male screw thread section is formed of a metal alloy.

12. The screw anchor of claim 11, wherein the metal alloy is based on iron, chrome and/or cobalt.

13. The screw anchor of claim 9, wherein the metallic body portion and thus the first male screw thread section integral thereto are formed of stainless steel.

14. The screw anchor of claim 9, wherein the second male screw thread section comprises at least part of a screw thread turn.

15. The screw anchor of claim 9, wherein a metal deposition technique, such as a laser metal deposition process, a plasma transferred arc welding process, a metal inert gas welding process, or a metal active gas welding process is used to form a screw thread section of the screw anchor.

16. The method of claim 1, wherein the first male screw thread section is helically aligned with the second male screw thread so that after the second male screw thread taps the female thread in the support, the first male screw thread enters the female threads to prevent axial removal of the screw anchor.

17. The method of claim 1, wherein after the step of tapping the thread of the first male screw thread is slightly larger than the female thread.

18. A method of anchoring a screw anchor comprising: forming a first male screw thread section on a metallic body the first male screw thread being integral to the metallic body; using a metal deposition technique to deposit a second male screw thread section on the metallic body; wherein the second male screw thread section is formed of metallic material having a greater hardness than the metallic body and the second male screw thread is in helical alignment with the first male screw thread, tapping out a female thread in a hole in a support, receiving the first male screw thread in the female thread when the screw anchor is twisted into the hole,

19. The method of claim 18, wherein the metallic body and the first male screw thread has a lower hardness than a material of the support and the second male screw thread has a greater hardness than the material of the support.

20. The method of claim 18, wherein the step of receiving the first male screw thread includes receiving the first male screw thread into the female thread, where the material of the first male screw thread is resistant to corrosion.
